(19) United States
(12) Patent Application Publication
(10) Pub. No.: US 2026/0316501 A1
(43) Pub. Date: Oct. 15, 2026

(54) VEHICLE COUPLING SYSTEM WITH WIRELESS EMITTER-RECEIVER UNIT

(71) Applicant: JOST-WERKE DEUTSCHLAND GMBH, Neu-lsenburg (DE)

(72) Inventors: José Manuel ALGÜERA, Aschaffenburg (DE); Michael FISCHER, Nagold (DE); Steffen HABER, Gross-Gerau (DE); Swen SAUPE, Mainz (DE)

(21) Appl. No.: 19/477,846

(22) PCT Filed: Apr. 23, 2024
(86) PCT No.: PCT/IB2024/053957

§ 371 Date: Oct. 23, 2025

(30) Foreign Application Priority Data
Apr. 24, 2023 (DE) 10 2023 001 659.4

(51) Int. Cl. B60D 1/62; B62D 53/08

(52) U.S. Cl. CPC B60D 1/62; B62D 53/0842; B62D 53/0885

(57) ABSTRACT

A vehicle coupling system with wireless emitter-receiver unit having a coupling device secured to a towing vehicle, and a trailer coupling means secured to a trailer vehicle and which is insertable into the coupling device and lockable in a bearing section of the coupling device, the locked trailer coupling means is held movably about a pivot axis (Z) relative to the coupling device, the emitter-receiver unit has at least one first transmitter arranged in a fixed position with respect to the coupling device relative to pivot axis (Z) and at least one second transmitter assigned to the trailer vehicle, the at least one second transmitter is arranged in fixed position relative to the trailer coupling means. First transmitters are provided arranged offset relative to one another in the circumferential direction about the bearing section, and/or a plurality of second transmitters are provided are arranged offset in circumferential direction about pivot axis (Z).

### FIELD OF THE INVENTION

The invention relates to a vehicle coupling system with a wireless emitter-receiver unit having a coupling device secured to a towing vehicle, and a trailer coupling means which is secured to a trailer vehicle and which is insertable into the coupling device and lockable in a bearing section of the coupling device, wherein the locked trailer coupling means is held movably about a pivot axis (Z) relative to the coupling device, the emitter-receiver unit has at least one first transmitter arranged in a fixed position with respect to the coupling device relative to the pivot axis (Z) and at least one second transmitter assigned to the trailer vehicle, wherein the at least one second transmitter is arranged in a fixed position relative to the trailer coupling means, wherein a plurality of first transmitters are provided which are arranged offset relative to one another in the circumferential direction about the bearing section, and/or that a plurality of second transmitters are provided which are arranged offset in the circumferential direction about the pivot axis (Z).

### BACKGROUND OF THE INVENTION

A vehicle coupling system is understood, in particular, to be a mechanical connection device between a towing vehicle and a trailer vehicle, as typically used in commercial freight transport. The coupling device of the towing vehicle can be, for example, a fifth wheel coupling, and the trailer coupling means can be a kingpin permanently installed on a semi-trailer. To couple the vehicles, the towing vehicle reverses towards the stationary semi-trailer and contacts the kingpin with its fifth wheel coupling until the kingpin is locked in its final position in the fifth wheel coupling. During driving, the semi-trailer pivots around its kingpin, which is rotatably held in the fifth wheel coupling, when cornering.

Systems are already known from the prior art that enable the mechanical coupling and uncoupling of the semi-trailer and simultaneously connect the supply lines, or disconnect it during uncoupling. Document DE 102018117584 A1 discloses such a plug-in coupling system with a connector for electrical and pneumatic supply lines. A female connector of the connector is located on the fifth wheel coupling of the towing vehicle, and a male connector located on the semi-trailer is pivotally mounted around the kingpin.

In addition to data transmission, the plug and socket have at least one transmitter and at least one receiver of a short-range contactless communication system. However, the relatively low data rate and high susceptibility to interference of the contactless communication system due to its structural proximity to electrical cables and contacts of the vehicle's electrical system have proven to be disadvantageous.

DE 10347561 B3 discloses a semi-trailer truck with a wireless signal transmitter. A voltage generator for generating a periodically fluctuating power signal is provided in the tractor unit of the semi-trailer truck. A first transmitter is arranged in the area of the fifth wheel plate of the tractor unit to transmit the power signal to a second transmitter in the area of the kingpin of the semi-trailer. The overall signal for powering a component, transmitted by inductive coupling, is present on the trailer's power supply line. Control signals can also be modulated onto the carrier voltage if necessary.

EP 3059103 A1 describes a control unit for a trailer coupling for a towing vehicle. The control unit has a reading device for communicating with an RFID transponder, which is arranged in particular on a coupling of the trailer or load carrier and in which at least one identification code is stored, and evaluation means for evaluating the at least one identification code.

DE 102017130957 A1 relates to a system for connecting a tractor to a trailer. Among other things, a light signal transmitter/receiver is arranged within the kingpin, which interacts with a light signal transmitter/receiver aligned on the fifth wheel coupling below the kingpin. Both light signal transmitters/receivers are aligned opposite each other in the axial extension of the kingpin.

DE 10244298 A1 discloses a system for connecting a tractor to a trailer. The trailer comprises a separate, automatically operating power generation device for generating electrical and/or pneumatic energy. The control of the trailer's traffic-related equipment is achieved by means of wirelessly transmitted signals between the tractor and the trailer.

### SUMMARY OF THE INVENTION

The invention was based on the object of providing a vehicle coupling system whose wireless emitter-receiver unit enables a high-frequency data rate with lower susceptibility to interference.

This object is achieved by the features of, during a rotary relative movement, data transmission switches to the geometrically closest pairing of the first transmitter and the second transmitter.

Due to the particularly short range between the first and second transmitters, the emitter-receiver unit allows large signal volumes to be transmitted reliably and without significant external interference. The range between the at least one first transmitter and the nearest at least one second transmitter is preferably between 3.00 mm and 30.00 mm. With greater distance, the risk of interference increases, whereas a specified minimum distance reduces the risk of damage from collisions between the first and second transmitters during driving.

The at least one first and second transmitter is understood to be either a transmitter and/or a receiver.

For communication from the towing vehicle to the trailer, the at least one first transmitter is a signaler and the at least one second transmitter is a receiver. In this configuration, only data transmission from the towing vehicle to the semi-trailer is possible. It is also possible for data to be transmitted exclusively from the semi-trailer to the towing vehicle.

In this case, the at least one second transmitter is a signaler, and the at least one first transmitter is a receiver. However, a configuration with bidirectional data transmission in full-duplex operation between the towing vehicle and the trailer vehicle is preferred. For this purpose, the at least one first transmitter comprises a signaler and a receiver, and the at least one second transmitter also comprises a signaler and a receiver. The respective signalers and receivers of the first or second transmitter can also be functionally combined in one component as transceivers.

The at least one first and second transmitter can preferably operate based on radio frequency identification (RFID), near field communication (NFC), Bluetooth Low Energy (BLE), optical signal transmission, or short-range radio technology. Radio transmission in the mm-wave range is particularly preferred. The carrier frequency can be 60 GHz, for example. Data transmission is preferably possible at up to 6.25 Gbit/s. The power transmission can be realized with up to 30 watts per first and/or second transmitter.

Typically, both the at least one first transmitter and the at least one second transmitter are connected to the respective data network of the towing vehicle or trailer vehicle via a cable connection.

A plurality of first transmitters are provided, which are arranged offset from one another in the circumferential direction around the bearing section. It is generally sufficient for fast data transmission if the plurality of first transmitters interact with one or, if necessary, several second transmitters. Multiple first and/or second transmitters advantageously increase the data rate and provide redundancy during operation.

Alternatively or additionally, several second transmitters can be arranged offset in the circumferential direction around the pivot axis and interact with at least one first transmitter. All embodiments have in common that the relative position of the first and second transmitter changes during driving, for example, when negotiating a curve. In particular, the data transmission switches to the pair of first and second transmitter that is geometrically closest during a rotational relative movement.

Advantageously, the at least one second transmitter is attached to the trailer coupling means. For this purpose, the second transmitter can in particular be inserted into the trailer coupling means and be flush with the surrounding surface or, for collision avoidance reasons, be slightly set back from it.

Expediently, the trailer coupling means is a kingpin, and the at least one second transmitter is attached to a cylindrical portion of the kingpin. The cylindrical section of the kingpin comprises, in particular, an upper collar, which usually transitions into a kingpin flange, a reduced-diameter collar, which serves to lock with a locking hook of the fifth wheel coupling, and a lower collar, which terminates the kingpin at the bottom.

Preferably, the at least one first transmitter is arranged offset with respect to the at least one second transmitter in the radial direction of the pivot axis and opposite one another at the same height level in the direction of the pivot axis. Data transmission thus takes place in a plane spanned by the longitudinal axis and the transverse axis of the fifth wheel coupling plate.

The cylindrical section can be formed from an upper collar of the kingpin, and the at least one first transmitter is inserted into a wear ring or wall section of the coupling device that at least partially surrounds the bearing section. A gap between the wear ring or the wall section of the coupling device and the upper collar of the kingpin can be bridged by means of wireless data transmission between the at least one first transmitter and the at least one second transmitter.

According to an alternative embodiment, the cylindrical section is formed from a lower collar of the kingpin, and the at least one first transmitter is inserted into a wall section of the coupling device that at least partially surrounds the bearing section. This region of the coupling device lies below the wear ring and, on the side of the kingpin, also requires a lower position for the at least one second transmitter, so that the corresponding first and second transmitters face each other at the same height in the radial direction of the kingpin and are separated only by the gap between the lower collar of the kingpin and the opposite wall section of the coupling device.

In the two variants mentioned above, the at least one first transmitter is preferably inserted into a wall section of the wear ring or wall section facing the cylindrical section of the kingpin. For this purpose, a recess can be formed for each first transmitter in the wall section of the wear ring or the coupling device facing the kingpin, into which the associated at least one first transmitter is inserted and held in place. Preferably, the at least one first transmitter is flush with the surrounding surface or is slightly recessed from it to avoid collisions.

It is also possible for the at least one first transmitter to be arranged offset with respect to the at least one second transmitter in the direction of the pivot axis and opposite one another in the radial direction. In this embodiment, data transmission takes place in the direction of the pivot axis.

For this purpose, it is particularly advantageous for the at least one first transmitter to be inserted into a wear ring or wall section of the coupling device that at least partially surrounds the bearing section, and the at least one second transmitter to be inserted in a kingpin flange or a mounting ring of the kingpin. The kingpin flange is usually an integral part of the kingpin. A mounting ring is understood to be an annular component that either serves to secure the kingpin or is part of a pivot bearing for an alignment wedge of a comfort coupling system. The kingpin flange and/or mounting ring projects beyond the wear ring in the radial direction of the kingpin and, if applicable, also beyond the surrounding wall section of the fifth wheel coupling plate. If the at least one second transmitter is arranged in the kingpin flange or a mounting ring, the first transmitter should be arranged at the same radial distance from the pivot axis in the wear ring or, if applicable, in the wall section of the fifth wheel coupling plate located behind it. The at least one first and second transmitter are essentially spaced apart by the gap between the top side of the fifth wheel coupling plate or the wear ring and the kingpin flange or mounting ring, which is usually set back from the trailer plate.

Preferably, the trailer coupling means is a kingpin, and the at least one first transmitter is attached to a locking hook of the fifth wheel coupling. The locking hook is pivotally mounted on the fifth wheel coupling plate and, in a plan view, has a U-shape with two essentially parallel legs.

Before the kingpin is received, the locking hook is in an open position, in which both legs are oriented rearward toward the entry opening of the fifth wheel coupling plate. When the kingpin reaches the bearing section provided for this purpose in the fifth wheel coupling plate, the kingpin is located between the two legs of the locking hook, and the locking hook pivots approximately 90 degrees. In this locked position of the locking hook, the kingpin is held rotatably about its pivot axis, but cannot escape from the fifth wheel coupling plate through the entry opening. Upon reaching the locked position, the locking hook is in a position stationary to the fifth wheel coupling plate, and thus also the at least one first transmitter attached to it.

According to a further alternative embodiment, the coupling device has a support arm that engages below the bearing section and to which the at least one first transmitter is attached. The support arm is also fixed to the towing vehicle-side coupling device, and thus also the at least one first transmitter attached to it.

Advantageously, the trailer coupling means is a kingpin, and the at least one second transmitter is arranged on the underside of a lower collar of the kingpin, thus very close to the pivot axis of the kingpin. With the help of the support arm, the at least one first transmitter can also be positioned particularly close to the pivot axis of the kingpin, resulting in minimal or no rotational offset when cornering compared to the at least one second transmitter, which is movably arranged relative to the at least one first transmitter.

If the coupling device is a fifth wheel coupling, the support arm can preferably engage a fifth wheel coupling plate and/or a web of the fifth wheel coupling plate and/or a stiffening rib of the fifth wheel coupling plate, or one of two bearing blocks, or a mounting plate arranged below the bearing blocks, or a cross member running between the bearing blocks, or a frame component of the towing vehicle.

Conveniently, several second transmitters are arranged offset around the pivot axis on the underside of the lower collar. When the kingpin rotates, the second transmitter, originally positioned above the at least one first transmitter, moves away; however, a neighboring second transmitter approaches by the same amount, so that the distance required for wireless data transmission is always maintained between the first and one of the second transmitters.

It is particularly expedient if the at least one first transmitter is arranged in a projected area below the lower collar of the kingpin. In this area, the at least one first transmitter is located particularly close to the pivot axis of the kingpin and also in a particularly protected area under the fifth wheel coupling plate.

### BRIEF DESCRIPTION OF THE DRAWINGS

The invention is explained in more detail below with reference to 14 Figures showing in

FIG. 1: a plan view of a coupling device in the form of a fifth wheel coupling with an emitter-receiver unit arranged in the wall section of a bearing section and in the upper collar of the kingpin according to a first embodiment;

FIG. 2: a longitudinal section through the coupling device with emitter-receiver unit according to the embodiment of FIG. 1;

FIG. 3: a longitudinal section through a coupling device with an emitter-receiver unit arranged in the wear ring and in the upper collar of the kingpin according to a second embodiment;

FIG. 4: a longitudinal section through a coupling device with an emitter-receiver unit arranged in the wall section of the bearing section and in the lower collar according to a third embodiment;

FIG. 5: a longitudinal section through a coupling device with an emitter-receiver unit arranged in the wear ring and in the mounting ring according to a fourth embodiment;

FIG. 6: a longitudinal section through a coupling device with an emitter-receiver unit arranged in the wall section of the bearing section and in the mounting ring according to a fifth embodiment;

FIG. 7: an exploded view of a kingpin with mounting ring and pivot bearing of a comfort coupling system;

FIG. 8: a cross-section through an emitter-receiver unit arranged on the wear ring and the upper collar of the kingpin according to FIG. 3 when the towing vehicle is traveling straight ahead;

FIG. 9: a cross-section according to FIG. 6 at an approximately 45° articulation angle between the towing vehicle and the trailer vehicle;

FIG. 10: a cross-section according to FIG. 8 and FIG. 9 at an approximately 90° articulation angle between the towing vehicle and the trailer vehicle;

FIG. 11: a longitudinal section through a coupling device with an emitter-receiver unit arranged in the locking hook and in the reduced-diameter collar according to a sixth embodiment;

FIG. 12: a cross-section through a coupling device with emitter-receiver unit slightly modified compared to FIG. 11 when the towing vehicle is traveling straight ahead.

FIG. 13: a longitudinal section through a coupling device with an emitter-receiver unit arranged on a support arm and on an underside of the lower collar according to a seventh embodiment, and

FIG. 14: a cross-section through the coupling device with emitter-receiver unit according to FIG. 13 with the towing vehicle traveling straight ahead.

### DETAILED DESCRIPTION OF THE INVENTION

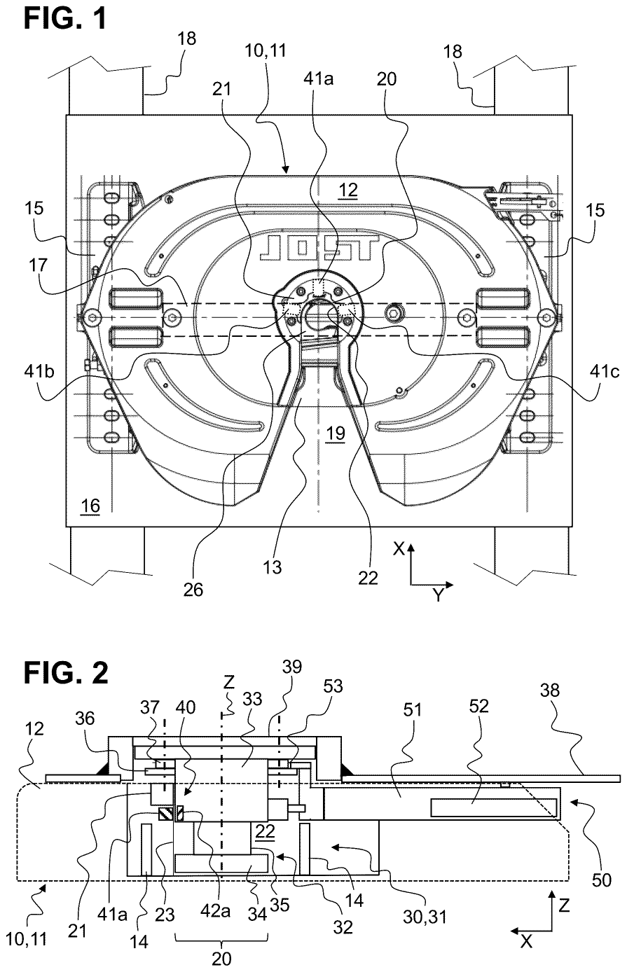

FIG. 1 shows a top view of a coupling device 10 in the form of a fifth wheel coupling 11. The fifth wheel coupling 11 has a fifth wheel coupling plate 12, which can be mounted directly to the frame components 18 of a towing vehicle (not shown here) arranged underneath by means of two bearing blocks 15 attached to both sides. Alternatively, the bearing blocks 15 can also be mounted on a common mounting plate 16 located underneath, which in turn is placed on top of the frame components 18 and connected to them.

A trailer coupling means 30 in the form of a kingpin 31 (see FIG. 2) for coupling a trailer vehicle (not shown here) enters a bearing section 20 of the coupling device 10 via an entry opening 19 of the fifth wheel coupling plate 12 that widens conically in the distal direction. In the bearing section 20, the kingpin 31 is held by a locking hook 26 that can pivot between an open position and a locked position. In the locked position shown in FIG. 1, the kingpin 31 can still pivot in both directions about a pivot axis Z while the towing vehicle is cornering.

When coupled, the semi-trailer rests with its trailer plate 38 on the upper side of the fifth wheel coupling plate 12.

A web 13 extends through the entry opening 19 and engages the fifth wheel coupling plate 12 on both sides. The web 13 is arranged at a height in the direction of the pivot axis Z such that a kingpin 31 can pass over it without collision while passing through the entry opening 19.

As shown in FIG. 2, one or more stiffening ribs 14 extend on the underside of the fifth wheel coupling plate 12 on both sides of the bearing section 20 up to the bearing blocks 15 to reinforce it.

The fifth wheel coupling 11 can be further stabilized by a cross member 17 running beneath the fifth wheel coupling plate 12, which is force-fit connected to the facing inner sides of the bearing blocks 15. The cross member 17 typically extends beneath the bearing section 20 of the coupling device 10.

The bearing section 20 of the coupling device 10 has a wear ring 21, which is inserted into the fifth wheel coupling plate 12 from above and is detachably connected to it. The kingpin 31, which is coupled and fixed by means of the locking hook 26, rests against the wear ring 21 and is subject to a not inconsiderable loss of material during driving, in particular due to cornering and deceleration of the towing vehicle, and thus to an increasing tolerance of the kingpin 31 relative to the fifth wheel coupling plate 12 over the operating time. If this tolerance becomes too large, the wear ring 21 can be replaced without major assembly effort.

In FIG. 1, three first transmitters 41a, 41b, 41c of an emitter-receiver unit 40 are arranged in a wall section 22 of the fifth wheel coupling plate 12 surrounding the bearing section 20. The first transmitters 41a, 41b, 41c are inserted in particular into a wall section 23 formed below the wear ring 21 on the fifth wheel coupling plate 12 and facing a cylindrical section 32 of the kingpin 31. The wall section 23 is oriented substantially vertically and runs parallel to the pivot axis Z.

Of the first transmitters 41a, 41b, 41c, only the first transmitter 41a, which is located at the front in the longitudinal axis X of the fifth wheel coupling plate 12, is visible in the longitudinal section of FIG. 2. This first transmitter 41a interacts with a second transmitter 42a of the emitter-receiver unit 40. The second transmitter 42a is fixedly mounted on an upper collar 33 of the cylindrical section 32 formed on the kingpin 31. The first transmitter 41a and the second transmitter 42a are aligned at the same height in the direction of the pivot axis Z and are directly opposite each other when the towing vehicle is traveling straight ahead.

In the exemplary embodiments shown in FIG. 2 to FIG. 6 and FIG. 9, a comfort coupling system 50 is installed to connect the supply lines between the towing vehicle and the trailer vehicle, for example, for the pneumatic or electrical power supply. With the aid of this system, the corresponding supply lines are automatically coupled during the mechanical coupling of the trailer vehicle. For this purpose, the comfort coupling system 50 comprises an alignment wedge 51 which is rotatably mounted on the kingpin 31 by means of a pivot bearing 53 and which, after the kingpin 31 has been locked, is located in the entry opening 19 within the bearing section 20 and is supported laterally on the fifth wheel coupling plate 12.

When negotiating curves, the kingpin 31 pivots relative to the alignment wedge 51, which is held stationary in the entry opening 19, so that plug-in couplings 52 for the supply lines (not shown) arranged at the distal end of the alignment wedge 51 with respect to the kingpin 31 can remain permanently connected and are decoupled from the relative movement between the towing vehicle-side coupling device 10 and the trailer coupling means 30.

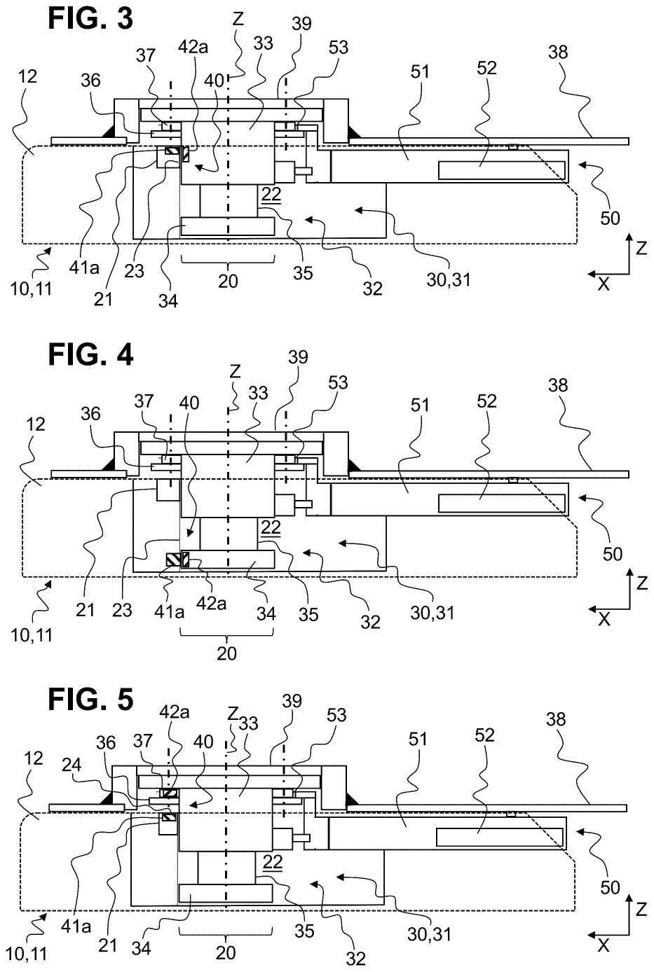

FIG. 3 shows a further embodiment of the invention in which the first transmitter 41a of the emitter-receiver unit 40 is integrated into the wear ring 21. The first transmitter 41a is inserted in particular into the substantially vertical wall section 23 facing the cylindrical section 32 of the kingpin 31 and is arranged at the same height in the direction of the pivot axis Z as the second transmitter 42a. The transmitter 42a is located in an upper collar 33 of the kingpin 31 and, when the towing vehicle is traveling straight ahead, is preferably aligned along the longitudinal axis X directly opposite the first transmitter 41a.

FIG. 4 illustrates a further, alternative arrangement of the emitter-receiver unit 40 in a further exemplary embodiment. The first transmitter 41a is also housed in the wall section 22 of the bearing section 20, which, as wall section 23, faces the cylindrical section 32 of the kingpin 31. However, the first transmitter 41a is located further down in the direction of the pivot axis Z, at the level of a lower collar 34 of the kingpin 31. A second transmitter 42a is provided in the lower collar 34, which is directly opposite the first transmitter 41a when the towing vehicle is traveling straight ahead.

FIG. 5 shows a further embodiment in which the first transmitter 41a is located in the wear ring 21.

The kingpin 31 is inserted into a kingpin mount 39, which is set back relative to the trailer plate 38, with its kingpin flange 36 and is fastened to the semitrailer. A mounting ring 37 is inserted between the kingpin flange 36 and the kingpin mount 39, which forms the stationary part of the pivot bearing 53 of the alignment wedge 51. The mounting ring 37 simultaneously supports a second transmitter 42a of the trailer vehicle along the longitudinal axis X in front of the upper collar 33 of the kingpin 31. In principle, it would also be possible to arrange the second transmitter 42a in the kingpin flange 36 located below.

The first transmitter 41a is arranged on a wall section 24 of the wear ring 21 facing the kingpin flange 36 and is located vertically offset below the second transmitter 42a in the direction of the pivot axis Z.

The embodiment of FIG. 6 differs from the variant shown in FIG. 5 in that the first transmitter 41a is not inserted into the wear ring 21, but rather into the wall section 24 of the fifth wheel coupling plate 12 facing the kingpin flange 36. In the radial direction to the pivot axis Z, the first transmitter 41a is arranged behind the wear ring 21. In the embodiment according to FIG. 6, the first transmitter 41a is also aligned below the second transmitter 42a in the direction of the pivot axis Z and preferably overlaps it at least partially.

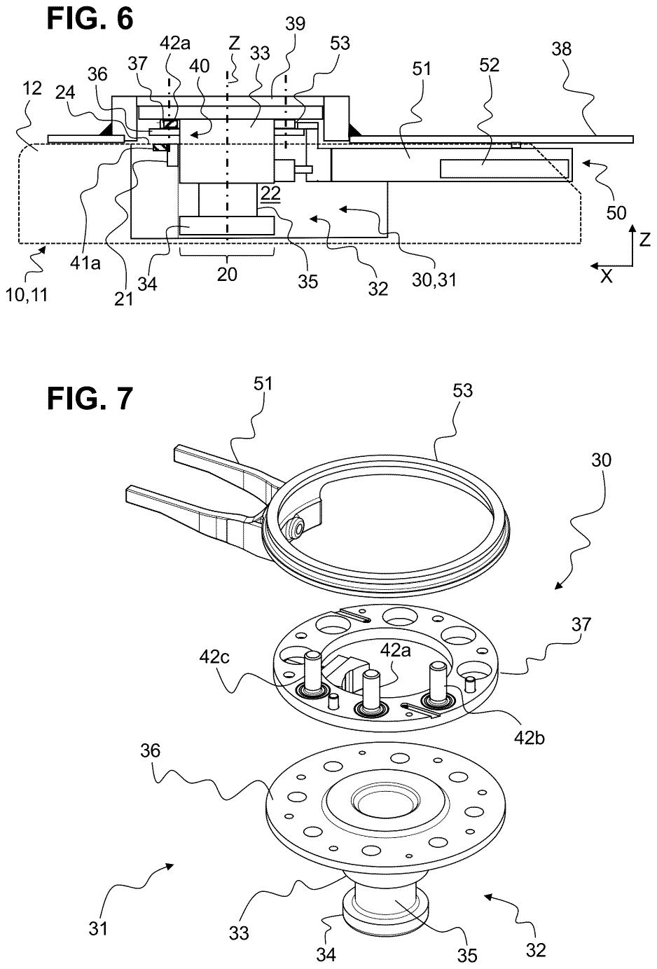

The exploded view of FIG. 7 illustrates the structure of the kingpin 31 with the mounting ring 37 and the pivot bearing 53 of the alignment wedge 51.

The mounting ring 37 is inserted between the kingpin flange 36 and the pivot bearing 53 of the alignment wedge 51, with three second transmitters 42a, 42b, 42c inserted into the mounting ring 37, offset in the circumferential direction.

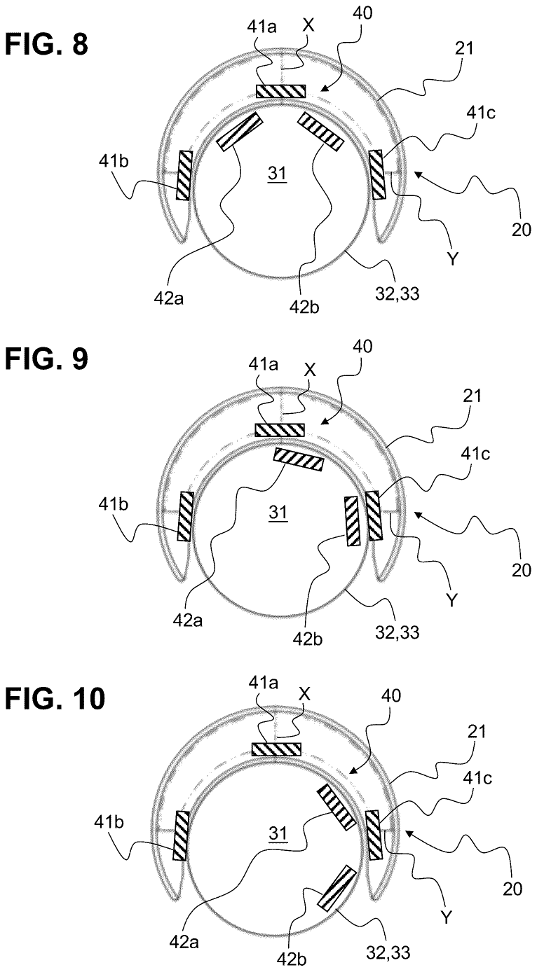

FIG. 8 to FIG. 10 show an exemplary arrangement of several first transmitters 41a, 41b, 41c and second transmitters 42a, 42b, mounted offset in the circumferential direction around the pivot axis Z. For example, according to the embodiment of FIG. 3, the first transmitters 41a, 41b, 41c are mounted in a wall section 23 in the wear ring 21 facing the cylindrical section 32 of the kingpin 31, and the second transmitters 42a, 42b are mounted on the upper collar 33 of the kingpin 31.

The presence of several first transmitters 41a, 41b, 41c and several second transmitters 42a, 42b not only provides redundancy but also improves signal transmission when the towing vehicle is cornering. During cornering, the relative position of the first transmitters 41a, 41b, 41c to the second transmitters 42a, 42b, which are fixedly mounted relative to the trailer coupling means 30, changes, as the kingpin 31 also rotates within the fifth wheel coupling plate 12 and changes its position. It is provided that, in the radial direction, there is always a functional overlap between at least one second transmitter 42a, 42b and the nearest first transmitter 41a, 41b, 41c for reliable data transmission.

In the situation shown in FIG. 8, the towing vehicle and the semi-trailer are aligned with each other along the longitudinal axis X of the fifth wheel coupling plate 12. Of the three first transmitters 41a, 41b, 41c arranged in the wear ring 21, the first transmitter 41a is positioned along the longitudinal axis X, and the two first transmitters 41b, 41c are positioned opposite each other on opposite sides of the kingpin 31 along a transverse axis Y of the fifth wheel coupling plate 12.

In the upper collar 33 of the kingpin 31, two second transmitters 42a, 42b are provided on either side of the longitudinal axis X. The two second transmitters 42a, 42b are each inserted into a recess open toward the wear ring 21 and are positioned opposite the first transmitter 41a with their inner ends facing each other, so that the distance to be overcome wirelessly between the first transmitter 41a and the two second transmitters 42a, 42b is minimal.

The first transmitters 41b, 41c, which are positioned opposite each other along the transverse axis Y, are comparatively further apart from the second transmitters 42a, 42b and, in the illustrated orientation of the kingpin 31 to the wear ring 21, are not involved in wireless data transmission.

In FIG. 9, the towing vehicle is negotiating a left turn and is aligned at approximately a 45° angle to the trailer vehicle. In this situation, which is common during driving and shunting operations, the second transmitter 42a, located in the upper collar 33 of the kingpin 31, is positioned closely opposite the first transmitter 41a, arranged along the longitudinal axis X, so that wireless data transmission can take place via the first transmitter 41a and 42a. At the same time, the second transmitter 42b has also moved toward the first transmitter 41c and is positioned directly opposite it, so that, alternatively or additionally, wireless data transmission can also take place via this pairing of the first transmitter 41c and the second transmitter 42b. The first transmitter 41b is relatively farther away from the two second transmitters 42a, 42b and therefore does not participate in wireless data transmission.

In FIG. 10, the articulation angle between the towing vehicle and the semi-trailer has increased even further and is approximately 90°. In this orientation, both second transmitters 42a, 42b located in the upper collar 33 of the kingpin 31 have migrated in the direction of the first transmitter 41c and are directly opposite it, at least in sections.

Wireless data transmission now occurs via one or both of the second transmitters 42a, 42b and the first transmitter 41c.

Even in all conceivable intermediate positions of the first transmitters 41a, 41b, 41c during driving operation, these are distributed circumferentially with respect to the second transmitters 42a, 42b in such a way that wireless data transmission is always possible via at least one spatially proximate pairing of at least one of the first transmitters 41a, 41b, 41c with at least one of the second transmitters 42a, 42b.

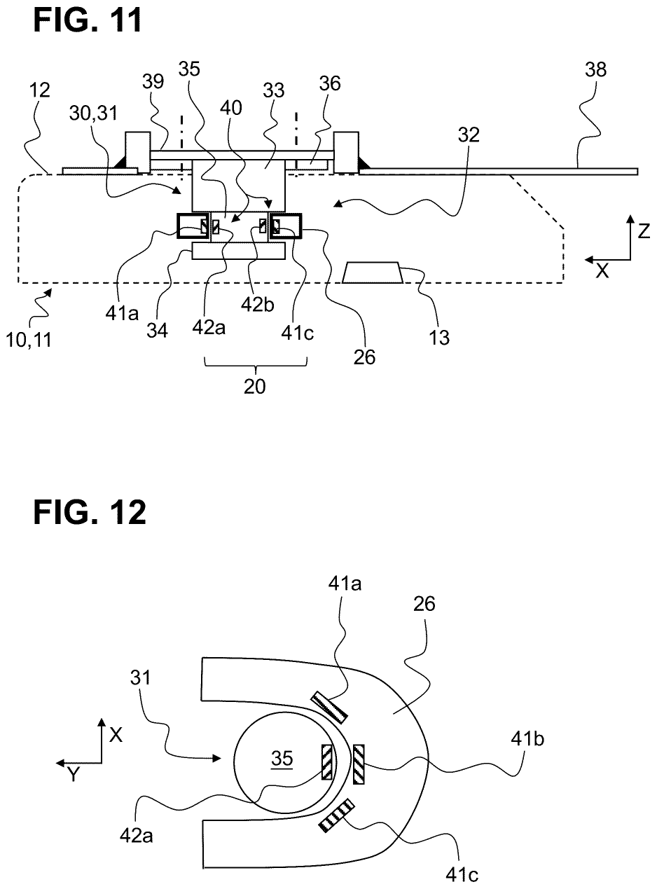

FIG. 11 and FIG. 12 shows a further embodiment in which the first transmitters 41a, 41b, 41c are attached to a locking hook 26 arranged on the underside of the fifth wheel coupling plate 12. The locking hook 26, before the kingpin 31 enters, is oriented with its free legs toward the entry opening 19. Upon the kingpin 31 entering the bearing section 20, the locking hook 26 pivots approximately 90°, and continuously engages a reduced-diameter collar 35 of the kingpin 31. In the locked end position of the kingpin 31, the locking hook 26 remains in a fixed position relative to the fifth wheel coupling plate 12.

According to FIG. 11, second transmitters 42a, 42b, which interact with the first transmitters 41a, 41b, 41c, are integrated into the reduced diameter collar 35 of the kingpin 31 for wireless data transmission. The second transmitters 42a, 42b are arranged at the same height level as the first transmitters 41a, 41b, 41c in the direction of the pivot axis Z. The visible first transmitters 41a, 41c are each located on the mutually facing inner sides of the U-shaped locking hook 26 and are thus offset from the nearest second transmitters 42a, 42b in the radial direction of the pivot axis Z.

In FIG. 12, the positioning of the first transmitters 41a, 41b, 41c has been slightly altered, and only a single second transmitter 42a is installed on the kingpin 31 side. In the straight-ahead position of the towing vehicle and semi-trailer shown, the second transmitter 42a is aligned along the transverse axis Y of the fifth wheel coupling plate 12 and is located directly opposite the first transmitter 41b, so that wireless data transmission takes place between the first transmitter 41b and the second transmitter 42a.

When negotiating a curve, the kingpin 31 rotates about its pivot axis Z, and the second transmitter 42a moves together with the kingpin 31, depending on the direction of the curve, either into the spatial proximity of the first transmitter 41a or into the spatial proximity of the first transmitter 41c. The wireless data transmission then takes place either via the first transmitter 41a and the second transmitter 42a or via the first transmitter 41c and the second transmitter 42a.

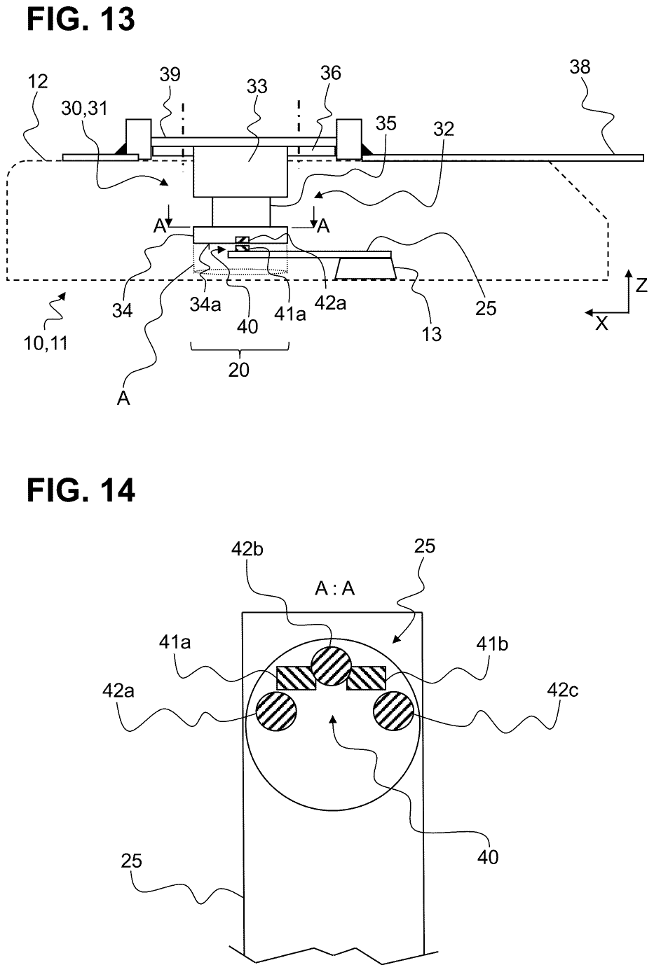

FIG. 13 and FIG. 14 illustrate the invention using a further exemplary embodiment, in which the first transmitters 41a, 41b assigned to the coupling device 10 are attached to a support arm 25 extending below the kingpin 31. In the exemplary embodiment of FIG. 13, the support arm 25 is fixedly attached to the web 13 of the fifth wheel coupling plate 12 by one end.

The two first transmitters 41a, 41b are attached to the free end of the support arm 25, in particular on its upper side, and are located directly opposite an underside 34a of the lower collar 34 of the kingpin 31. In this fixed position, the first transmitters 41a, 41b are always arranged in a projected area A below the lower collar 34 when the kingpin 31 is locked in the fifth wheel coupling 10.

The second transmitters 42a, 42b, 42c assigned to the trailer coupling means 30 are inserted into the lower collar 34 of the kingpin 31, offset from one another in the circumferential direction, and protrude at least partially from the underside 34a of the kingpin 31 or are inserted in the underside 34a in an exposed manner.

During driving, depending on the direction of travel around a curve, changes in the position of the first transmitters 41a, 41b, which are stationary with respect to the coupling device 10, occur relative to the second transmitters 42a, 42b, 42c, which are rotationally movable with respect to the coupling device 10 when cornering.

In FIG. 14, the towing vehicle with the semitrailer is in a straight-ahead, extended position. The second transmitter 42b, attached to the lower collar 34 of the kingpin 31, overlaps between the two first transmitters 41a, 41b, which are attached side by side on the underlying support arm 25. Wireless data transmission takes place via one or both of the first transmitters 41a, 41b and the second transmitter 42b. When the towing vehicle and thus the support arm 25 swivels, the support arm 25 moves together with the first two transmitters 41a, 41b either under the second transmitter 42a or the second transmitter 42c, depending on the direction of the curve. As the swivel angle increases, the distance between at least one of the first transmitters 41a, 41b and the respective second transmitter 42a, 42c becomes shorter, so that wireless data transmission is also realized via this transmitter.

### LIST OF REFERENCE NUMERALS

10 coupling device
11 fifth wheel coupling
12 fifth wheel coupling plate
13 fifth wheel coupling plate web
14 fifth wheel coupling plate stiffening rib
15 bearing block
16 mounting plate
17 cross member
18 towing vehicle frame component
19 entry opening
20 coupling device bearing section
21 wear ring
22 wall section bearing section
23 wall section facing cylindrical section
24 wall section facing kingpin flange
25 support arm
26 locking hook
30 trailer coupling means
31 kingpin
32 cylindrical section kingpin
33 upper collar kingpin
34 lower collar kingpin
34a underside lower collar
35 reduced diameter collar
36 kingpin flange
37 mounting ring
38 trailer plate
39 kingpin mount for trailer plate
40 emitter-receiver unit
41a-c first transmitter for towing vehicle
42a-c second transmitter for trailer vehicle
50 comfort coupling system
51 alignment wedge
52 plug-in coupling for supply lines
53 pivot bearing
A projected area
X longitudinal axis
Y transverse axis
Z pivot axis

What is claimed is:

1. A vehicle coupling system, comprising a wireless emitter-receiver unit, having a coupling device secured to a towing vehicle, and a trailer coupling means which is secured to a trailer vehicle and which is insertable into the coupling device and lockable in a bearing section of the coupling device, wherein the locked trailer coupling means is held movably about a pivot axis (Z) relative to the coupling device, the emitter-receiver unit has at least one first transmitter arranged in a fixed position with respect to the coupling device relative to the pivot axis (Z) and at least one second transmitter assigned to the trailer vehicle, wherein the at least one second transmitter is arranged in a fixed position relative to the trailer coupling means,
wherein a plurality of first transmitters are provided which are arranged offset relative to one another in the circumferential direction about the bearing section, and/or that a plurality of second transmitters are provided which are arranged offset in the circumferential direction about the pivot axis (Z), and
wherein during a rotary relative movement, data transmission switches to the geometrically closest pairing of the first transmitter and the second transmitter.

2. The vehicle coupling system according to claim 1, wherein the at least one second transmitter is attached to the trailer coupling means.

3. The vehicle coupling system according to claim 1, wherein the trailer coupling means is a kingpin and the at least one second transmitter is attached to a cylindrical portion of the kingpin.

4. The vehicle coupling system according to claim 3, wherein the at least one first transmitter is arranged offset with respect to the at least one second transmitter in the radial direction of the pivot axis (Z) and opposite one another at the same height level in the direction of the pivot axis (Z).

5. The vehicle coupling system according to claim 3, wherein the cylindrical section is formed from an upper collar of the kingpin and the at least one first transmitter is inserted into a wear ring or wall section of the coupling device which at least partially surrounds the bearing section.

6. The vehicle coupling system according to claim 3, wherein the cylindrical section is formed from a lower collar of the kingpin and the at least one first transmitter is inserted into a wall section of the coupling device which at least partially surrounds the bearing section.

7. The vehicle coupling system according to claim 5, wherein the at least one first transmitter is inserted into a wall section of the wear ring or wall section facing the cylindrical section of the kingpin.

8. The vehicle coupling system according to claim 1, wherein the at least one first transmitter is arranged offset with respect to the at least one second transmitter in the direction of the pivot axis (Z) and opposite one another in the radial direction.

9. The vehicle coupling system according to claim 8, wherein the at least one first transmitter is inserted in a wear ring or wall section of the coupling device that at least partially surrounds the bearing section, and the at least one second transmitter is inserted in a kingpin flange or a mounting ring of the kingpin.

10. The vehicle coupling system according to claim 8, wherein the at least one first transmitter is inserted into a wall section of the wear ring or wall section of the coupling device facing the kingpin flange or mounting ring of the kingpin.

11. The vehicle coupling system according to claim 1, wherein the trailer coupling means is a kingpin and the at least one first transmitter is fastened to a locking hook.

12. The vehicle coupling system according to claim 1, the coupling device has a support arm which engages below the bearing section and to which the at least one first transmitter is fastened.

13. The vehicle coupling system according to claim 12, wherein the coupling device is a fifth wheel coupling, wherein the support arm engages a fifth wheel coupling plate and/or a web of the fifth wheel coupling plate and/or a stiffening rib of the fifth wheel coupling plate or one of two bearing blocks or a mounting plate arranged under the bearing blocks or a cross member running between the bearing blocks or a frame component of the towing vehicle.

14. The vehicle coupling system according to claim 12, wherein the trailer coupling means is a kingpin and the at least one second transmitter is arranged on the underside of a lower collar of the kingpin.

15. The vehicle coupling system according to claim 14, wherein on the underside of the lower collar a plurality of second transmitters are arranged offset about the pivot axis (Z).

16. The vehicle coupling system according to claim 14, wherein the at least one first transmitter is arranged in a projected area (A) below the lower collar of the kingpin.

17. The vehicle coupling system according to claim 2, wherein the trailer coupling means is a kingpin and the at least one second transmitter is attached to a cylindrical portion of the kingpin, wherein the at least one first transmitter is arranged offset with respect to the at least one second transmitter in the radial direction of the pivot axis (Z) and opposite one another at the same height level in the direction of the pivot axis (Z), and wherein the cylindrical section is formed from an upper collar of the kingpin and the at least one first transmitter is inserted into a wear ring or wall section of the coupling device which at least partially surrounds the bearing section.

18. The vehicle coupling system according to claim 2, wherein the trailer coupling means is a kingpin and the at least one second transmitter is attached to a cylindrical portion of the kingpin, wherein the at least one first transmitter is arranged offset with respect to the at least one second transmitter in the radial direction of the pivot axis (Z) and opposite one another at the same height level in the direction of the pivot axis (Z), and wherein the cylindrical section is formed from a lower collar of the kingpin and the at least one first transmitter is inserted into a wall section of the coupling device which at least partially surrounds the bearing section.

19. The vehicle coupling system according to claim 2, wherein the at least one first transmitter is arranged offset with respect to the at least one second transmitter in the direction of the pivot axis (Z) and opposite one another in the radial direction, and wherein the at least one first transmitter is inserted in a wear ring or wall section of the coupling device that at least partially surrounds the bearing section, and the at least one second transmitter is inserted in a kingpin flange or a mounting ring of the kingpin.

20. The vehicle coupling system according to claim 13, wherein the trailer coupling means is a kingpin and the at least one second transmitter is arranged on the underside of a lower collar of the kingpin, wherein on the underside of the lower collar a plurality of second transmitters are arranged offset about the pivot axis (Z), and wherein the at least one first transmitter is arranged in a projected area (A) below the lower collar of the kingpin.
